(19) United States
(12) Patent Application Publication
(10) Pub. No.: US 2024/0035874 A1
(43) Pub. Date: Feb. 1, 2024

(54) System for Detecting Cryogenic Liquid Level with Multi-Axis Magnetometer

(71) Applicants: Dmitry Taveren, McCormick, SC (US); Arnato Spagnoletti, Ramsey, NJ (US)

(72) Inventors: Dmitry Taveren, McCormick, SC (US); Arnato Spagnoletti, Ramsey, NJ (US)

(21) Appl. No.: 18/223,094

(22) Filed: Jul. 18, 2023

Related U.S. Application Data
(60) Provisional application No. 63/392,233, filed on Jul. 26, 2022.

(51) Int. Cl. G01F 23/62; G01F 23/80; F17C 13/02

(52) U.S. Cl. CPC G01F 23/62; G01F 23/804; F17C 13/026; F17C 2250/0413; F17C 2250/0491; F17C 2223/0161; F17C 2250/0439; F17C 2201/0109; F17C 2205/018; F17C 2201/032; F17C 2250/034

(57) ABSTRACT

A system provides a level detector with a multi-axis magnetometer sensor that senses movement of a magnet connected to a float within a vessel. A temperature sensor may assist in compensating for changes to the magnetic field due to ambient temperature. Output from the sensor is provided to a local data processing unit which provides level data to a local display. The local data processing unit sends data through a communications port to a remote system which can track level remotely as well as assimilate and uniquely characterize data from other vessels to provide more accurate level measurement by the local processing unit.

### CLAIM OF PRIORITY

This application claims the benefit of U.S. Provisional Application No. 63/392,233 filed Jul. 26, 2022, which is incorporated herein by reference in its entirety.

### FIELD OF THE INVENTION

The invention relates generally to systems for detecting cryogenic liquid level with high-sensitivity multi-axis magnetometer and, preferably, cloud data & analytics platform.

### BACKGROUND OF THE INVENTION

Currently, there are a number of solutions for monitoring/detecting cryogenic liquid level in tanks/containers/vessels/devices. Some of these solutions attempt to use Differential Pressure (DP) sensors, but these solutions fail to meet the needs of the industry because many cryogenic vessels are not equipped to accept DP sensors, they are more expensive than float assemblies and not commercially viable for many applications, and often times require the tank to be taken out of service for retrofit to DP sensors.

Other solutions attempt to use Capacitance Probes, but these solutions are similarly unable to meet the needs of the industry because they are more expensive and require the vessels to be emptied and taken out of service thereby creating significant retrofit costs for labor, hardware, and lost product.

Still, other solutions seek to measure weight, but these solutions also fail to meet industry needs because they are more expensive, require significant labor to install and place tank onto weight-based system (e.g. scale, load cells, etc.), and are prone to false readings as items tend to be placed on tanks creating erroneous data.

Rochester Gauges, and possibly other companies use Hall-Effect sensors to generate voltage signal output proportional to the magnetic field of the magnet located near the upper end of the cryogenic vessel float assembly shaft or installed on mechanical level gauge indicators, but these solutions also fail to meet industry needs because such sensors are unable to provide sufficient magnetic field measurement precision and range, do not take into account magnetic field vector components and angular movements of float assemblies, are drastically affected by the change in external temperatures and by magnetic fields of magnets embedded into the mechanical level gauge indicators and/or presence of other magnetic interference/noise, and tend to have excessive power consumption.

### SUMMARY OF THE INVENTION

It is an object of many embodiments of the present invention to provide a system that automatically detects with high precision the level of cryogenic liquid inside various tank/container/vessel/devices by monitoring the movement of internal float assemblies.

Furthermore, it is an object of many embodiments of the present invention to provide system that can be easily and economically installed regardless of whether vessel is in operation or sitting idle, and without a need to require disassembly and/or emptying of the cryogenic liquid vessel and/or reducing vessel pressure.

Still, further, it is an object of many embodiments of the present invention to provide a system that may be utilized with any type of float assemblies (e.g. horizontal, vertical, short, long, etc.), and take into account magnetic field vector components of float assemblies in an effort to potentially automatically and accurately calculate the precise level of cryogenic liquid with adjustments for angular/side movements of internal float assemblies.

Furthermore, it is an object of many embodiments of the present invention to provide a system that could be minimally affected by the change in external temperatures and/or presence of magnetic interference/noise (such as from magnets embedded into the mechanical level gauge indicators), and/or run autonomously using minimal power from an embedded battery.

Additionally, it is an object of many embodiments of the present invention to provide a system that may automatically analyze and process cryogenic liquid level data for multiple monitored cryogenic liquid vessels for a variety of commercial/operational efficiency, safety, and quality benefits.

Furthermore, it is an object of many embodiments of the present invention to provide a system that has a digital local display with ultra-low power consumption for local visualization of the cryogenic liquid level and system operation. Many embodiments of the system advantageously fill these needs and addresses the aforementioned deficiencies by providing a highly integrated and fully automated system with digital, energy efficient, and highly precise multi-axis magnetometer sensor, combined with digital electrochromic (e-paper as an example) display, together comprising a unit that is non-intrusively mounted externally, such as on an external part of cryogenic liquid vessel internal float assembly to collect cryogenic liquid level data for further processing, such as by cloud data and analytics platform, or other analytics.

Disclosed are embodiments of a system together with an associated computer process. The system may be made up of the following components and/or others: a high-sensitivity multi-axis magnetometer sensor, a data processing device, a display such as an electrochromic (e-paper) display, and software such as a cloud data and analytics platform. These components are related as follows: (1) a sensor, such as a multi-axis high-sensitivity magnetometer sensor is mounted proximate to or on the external part of the tank/container/vessel/device internal float assembly. Such internal float assembly typically has a magnet located at the upper end of the float shaft, that moves with the change of cryogenic liquid level and corresponding buoyancy of the internal float. The internal float assembly is installed inside the tank/container/vessel/device. (2) By positioning the system's high-sensitivity multi-axis magnetometer sensor on the external portion of the float assembly directly nearby the float shaft magnet, and preferably having it precisely aligned to the float center, it is possible to non-intrusively detect magnetic field for each of the monitored dimensional axes (XYZ) and utilize the processing power of the software, such as in the form of the cloud data and analytics platform to further calculate additional magnetic field dimensional parameters (e.g. magnetic field azimuth and inclination, field vector, liquid level, withdrawal rate, etc.). (3) The Multi-axis sensor may be connected to and powered by the data processing device. Data processing capability device collects, controls and locally visualizes sensor characteristics as well as data output. (4) The display, such as a digital electrochromic (e-paper) display is embedded in, or located proximate to, the multi-axis sensor unit to locally visualize cryogenic liquid level and system operation often with ultra-low power consumption. (5) Furthermore, the data processing device also may aggregate corresponding sensor data and exchange data back and forth with the cloud data and analytics platform for further processing, analysis, and interactions.

Preferred type of sensors, such as the multi-axis high-sensitivity magnetometer sensor may be based on the Magneto-Impedance or Magneto-Resistive physical principle that provides extremely precise magnetic field sensing accuracy; in addition to best anti-noise sustainability, current consumption, and response speed. At least some of these features permit ultra-low-current measurements of minute variations in the magnetic field with high accuracy. Nevertheless, other types of magnetometers (Hall-Effect, future improvements, etc.) could be potentially used as a substitute as long as their characteristics and performance are appropriately developed for the application.

Functionality of the software, often cloud data and analytics platform, enable automatic and intelligent unique characterization of data from each installed multi-axis high-sensitivity magnetometer sensor, to accurately perform the measurement of magnetic field magnitude and/or vector components relative to the change against the uniquely defined baseline. Additionally, high-precision magnetic field dimensional parameters (e.g. magnetic field azimuth and inclination, field vector, etc.) may be calculated by the software, the cloud data and analytics platform, to take into account and compensate for possible angular movements of float assemblies. Together such functionality of cloud data and analytics platform, combined with multi-axis high-sensitivity magnetometer sensor readings provide ability to accurately, reliably, and efficiently calculate level of cryogenic liquid inside various tanks/containers/vessels/devices, based on the dimensional movements of internal float assemblies.

The system may also have one or more of the following components/features: temperature sensing elements embedded in the magnetometer sensor, battery and/or solar power supply sources for data processing device, local audio/visual notification components, AI-driven (Artificial Intelligence) algorithms and/or mathematical software models may process sensor data in or with the software, the cloud data and analytics platform, and mobile App for user interaction; which all may expand the functionality of the system as follows. A sensor, such as a high-sensitivity multi-axis magnetometer sensor may additionally include or be partnered with an integrated temperature sensor for automatic transmission of temperature data through the data processing device for further monitoring and analysis, as well as be used to compensate for possible temperature-dependent magnetic field changes.

The sensor, a high-sensitivity multi-axis magnetometer sensor and/or data processing device may be powered by battery and/or solar power supply sources for simple system installation and maintenance. Electrochromic (e-paper) display and other types of local audio/visual notification components may be embedded in, or partnered with, the data processing device or located separately, to provide local notification of liquid level in cryogenic vessel and/or other related information that may be generated locally and/or remotely with cloud data and analytics platform. Such software, such as the cloud platform may also host or be partnered with AI-driven data processing algorithms and/or mathematical software models to uniquely characterize each monitored cryogenic liquid vessel; automatically improve liquid level calculation accuracy; enable self-calibration functionality; and/or provide for scalable, in-depth analysis of cryogenic liquid vessel characteristics.

The system may also include a mobile and/or web App that can be installed on local users' mobile devices. Such App can remotely connect to the cloud data and analytics platform for visualization and interaction with related aggregated cryogenic liquid vessel data, and possibly also have functionality to wirelessly connect locally to the data processing device for visualization, configuration, and interactions.

Embodiments of the disclosed system are believed to be unique when compared with other known systems and solutions in that it provides an easy, non-intrusive, and inexpensive way to quickly field retrofit cryogenic liquid vessels of multiple sizes for automatic monitoring/detection of cryogenic liquid level. Installation of the system doesn't require emptying and/or reducing pressure of the cryogenic liquid vessels, any disassembly, relocation of the vessel, or taking it out of service permanently or temporarily for many embodiments. The high-sensitivity multi-axis magnetometer sensor unit may snap, or otherwise connect, onto the existing external elements of the cryogenic liquid vessel's internal float assembly, allowing to quickly retrofit thousands of cryogenic vessels with no special training required for its installation.

Utilization of magneto-impedance or magneto-resistive sensing elements in a sensor such as the high-sensitivity multi-axis magnetometer sensor provides very precise measurements of the cryogenic vessel float movements across a very wide range. In addition, these measurements may have minimal distortion from changes in external ambient temperatures and possible presence of magnetic interference/noise. Operation of magneto-impedance or magneto-resistive sensor requires much less energy than conventional Hall Effect sensors, allowing to operate local components of the system from battery and/or solar sources for much longer periods, and allows local components to be smaller in size with lower hardware cost.

Multiple axis sensing capabilities of the sensor, a high-sensitivity multi-axis magnetometer sensor, allows measurement of magnetic forces along all dimensional axes (X, Y, and Z), and calculation of additional magnetic field dimensional parameters (e.g. magnetic field azimuth and inclination, magnetic field vector, etc.) of the magnet located at the upper end of the cryogenic vessel float assembly shaft. Such parameters make it possible to build a mathematical software model for further data processing, such as in the cloud data and analytics platform, that may significantly increase accuracy of cryogenic liquid level measurements using the internal float assembly. Such unique mathematical software model, possibly hosted in the cloud data and analytics platform or embedded into the local data collection device, enables automatic and intelligent characterization of multi-axis high-sensitivity magnetometer sensor data; to accurately, reliably, and efficiently calculate level of cryogenic liquid inside various tanks/containers/vessels/devices, based on the measurement of magnetic field magnitude and/or vector components relative to the change against the uniquely defined baseline, also taking into account possible angular movements of float assemblies. A display, such as a digital electrochromic (e-paper) display embedded in the sensor unit enables local visualization of the cryogenic liquid level and system operation with ultra-low power consumption. Since such display may be printed on a plastic substrate it offers lowest cost of production with unlimited customization options but is still very durable in terms of physical impact, bending, and piercing. It will not break, crack, or shatter like conventional glass-based displays. It will operate across a very wide temperature range. Other displays may be employed with various other embodiments.

Embedded in the magnetometer sensor may be a temperature sensing functionality to monitor ambient temperature in and around the sensor and include it as an additional data stream for more precise liquid level data calculation such as in the cloud data and analytics platform. The system may utilize functionality of the remote cloud data and analytics platform along with hosted AI-driven data processing algorithms and/or mathematical software models to uniquely characterize each monitored cryogenic liquid vessel to automatically improve liquid level calculation accuracy, enable self-calibration functionality, and/or provide for scalable in-depth analysis of cryogenic liquid vessel characteristics.

The disclosed system or device is believed to be superior in that the overall architecture of the system is unique due to the presence of high-sensitivity sensor, such as a multi-axis magnetometer sensor, a data processing device, a display such as an electrochromic (e-paper) display, and software, such as cloud data and analytics platform. These components together form a comprehensive, easy to deploy, highly integrated, and fully automated system capable of detecting with high precision the level of cryogenic liquid inside tanks/containers/vessels/devices.

This disclosure will now provide a more detailed and specific description that will refer to the accompanying drawings. The drawings and specific descriptions of the drawings, as well as any specific or alternative embodiments discussed, are intended to be read in conjunction with the entirety of this disclosure. The System for Detecting Cryogenic Liquid Level with Multi-Axis Magnetometer may, however, be embodied in many different forms and should not be construed as being limited to the embodiments set forth herein; rather, these embodiments are provided by way of illustration only and so that this disclosure will be thorough, complete, and fully convey understanding to those skilled in the art.

### BRIEF DESCRIPTION OF THE DRAWINGS

FIG. 1 is a schematic diagram that illustrates the architecture of a presently preferred embodiment of the system.

FIG. 2. shows a front view of exemplary installation of multi-axis magnetometer on a cryogenic vessel.

FIG. 3. shows a detailed view of exemplary installation of multi-axis magnetometer on a cryogenic vessel with high-sensitivity magnetometer sensor dimensional axis aligned with the internal float center.

FIG. 4. shows a front perspective view of an exemplary embodiment of multi-axis sensor unit with electrochromic (e-paper) display, mounted on the external element of the cryogenic liquid vessel's internal float assembly.

FIG. 5. shows graphs of an exemplary embodiment of data processing output from the cloud data and analytics platform.

### DETAILED DESCRIPTION

The present invention is directed to system for detecting cryogenic liquid level with high-sensitivity multi-axis magnetometer.

In a presently preferred embodiment, the system or device is made up of the following components: high-sensitivity multi-axis magnetometer sensor 1 likely based on the magneto-impedance or magneto-resistive physical principle, coupled with embedded temperature sensing such as a temperature sensor 11; data processing device 2 possibly powered by battery 13 and potentially paired with solar energy through a solar panel 15 or otherwise as an option; a display 10, such as electrochromic (e-paper) display connected to or embedded into or with the multi-axis sensor 1 for local on-site visual notification; AI-driven (Artificial Intelligence) algorithms and mathematical software models to process sensor data in the cloud data and analytics platform 3; and mobile App 4 for user interaction.

At least some of these components may be combined together to create an architecture for the system or device 20 that may have both local and remote technology components together comprising a highly integrated, automated cryogenic liquid level detection system. Magneto-impedance or magneto-resistive high-sensitivity multi-axis magnetometer sensor 1 with integrated temperature sensor 11 is preferably installed locally on the monitored cryogenic liquid vessel 5, on the exterior surface 7 of the vessel 5 relative to a magnet 14 of the internal float shaft assembly 6 which is normally externally disposed relative to the vessel 5 at an upper end of a shaft 19. Local data processing device 3 (that is powered by battery 13 and/or solar energy 15, unless connected to building power, which is certainly an option) may be connected to the high-sensitivity magnetometer sensor 1, supplying it with power for operation, and potentially enabling bi-directional communication with the sensor 1 for collection, control and local visualization (with digital electrochromic display 10) of sensor characteristics, cryogenic liquid level, and/or system operation.

Furthermore, data processing device 2 also aggregates corresponding sensor data and exchanges data with remote cloud data and analytics platform 16 for further processing, analysis and interactions for at least some embodiments. Data processing device 2 also may have embedded display 10 (e.g. LCD or electrochromic display) for local notification of other related information. Additionally, data processing device 2 may be wirelessly connected to a separate external wireless speaker 17, that may provide audible alerts and/or voice messages remotely generated by the cloud data and analytics platform 16 and transmitted to the data processing device 2 for playback unless generated at the data processing device 2 independently of data from the cloud data and analytics platform 16. Remote cloud data and analytics platform 16 may host AI-driven data processing algorithms and/or mathematical software models to potentially automatically and intelligently characterize multi-axis high-sensitivity magnetometer sensor data for each monitored cryogenic liquid vessel 5; to assist in accurately, reliably, and/or efficiently calculating level of cryogenic liquid based on the measurement of magnetic field magnitude and/or vector components relative to the change against the uniquely defined baseline, also taking into account possible angular movements of float assemblies 6. Remote cloud data and analytics platform 3, 16 also may assist in enabling automatic improvements of liquid level calculation accuracy, self-calibration functionality, and/or scalable in-depth analysis of cryogenic liquid vessel characteristics. System also may include a mobile/web App 4 enabled on local users' mobile devices 18 and/or computer devices 22. Such App 4 may remotely connect to the cloud data and analytics platform 3 for visualization and interaction with related aggregated cryogenic liquid vessel data, and also may have functionality to wirelessly connect locally to the data processing device 2 for visualization, configuration, and/or interactions.

It should further be noted that: high-sensitivity multi-axis magnetometer sensor 1 is installed by simply affixing it via a simple “snap-on” process or other connection method to the external element of the existing float assembly 6. There is no need to empty the vessel 5, reduce pressure, temporarily suspend/modify its operation, or move vessel or its components in any way for many embodiments. Utilization of magneto-impedance or magneto-resistive sensing functionality in the high-sensitivity multi-axis magnetometer sensor 1, in combination with a local display 10, particularly an electrochromic (e-paper) display enables the sensor 1 to be very small, minimize power consumption, and achieve extremely high sensitivity along with extended measurement range and accuracy with minimal distortion from change in external temperatures and magnetic interference/noise. Additionally, embedded multiple axis sensing capabilities of the high-sensitivity multi-axis magnetometer sensor 1 allow precise measurement of magnetic forces along all dimensional axes (X, Y, and Z axes), and calculation of additional magnetic field dimensional parameters (e.g. magnetic field azimuth and inclination, magnetic field vector, etc.) of the magnet 14 located at the upper end of the cryogenic vessel float assembly shaft 19.

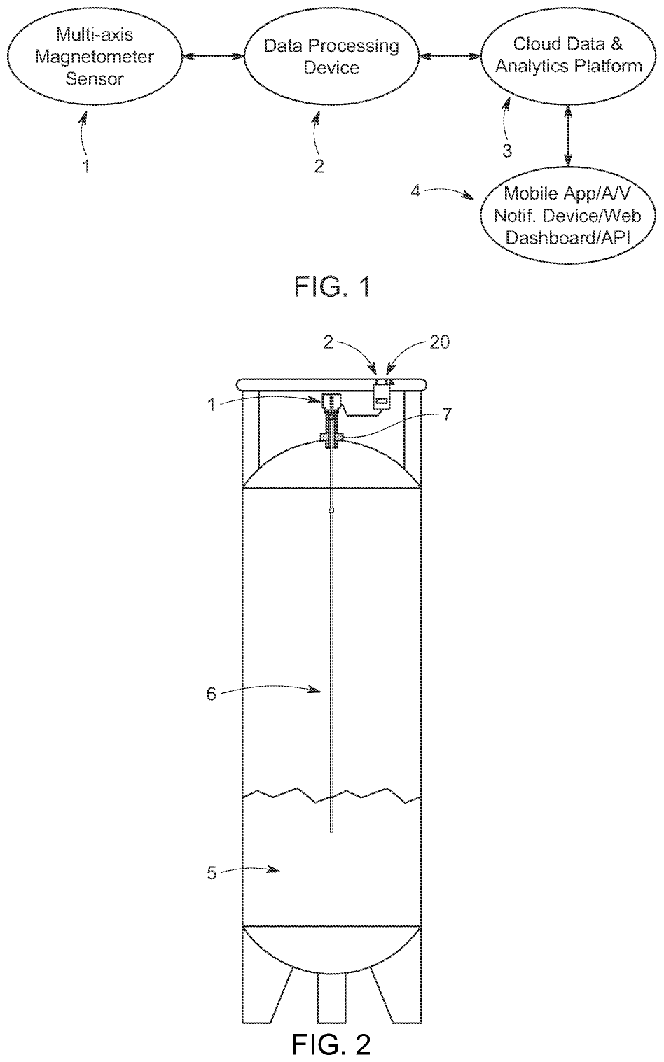

FIG. 1 is a schematic diagram that illustrates the architecture of system for detecting cryogenic liquid level with a multi-axis magnetometer sensor 1. High-sensitivity Multi-Axis Magnetometer Sensor 1 at least provides an output to a local data processing device 2, if not exchanging its performance data and is being controlled by Data Processing Device 2 that may communicate with Cloud Data and Analytics Platform 3 through a port 21, which is a communications port, which could employ wi-fi, Bluetooth, cellular data, or be wired as would be understood by those of ordinary skill in the art. Users may be able to access information with Mobile App, Audio/Video Notification Device, Web Dashboard, API Interface 4 (or other similar functional process).

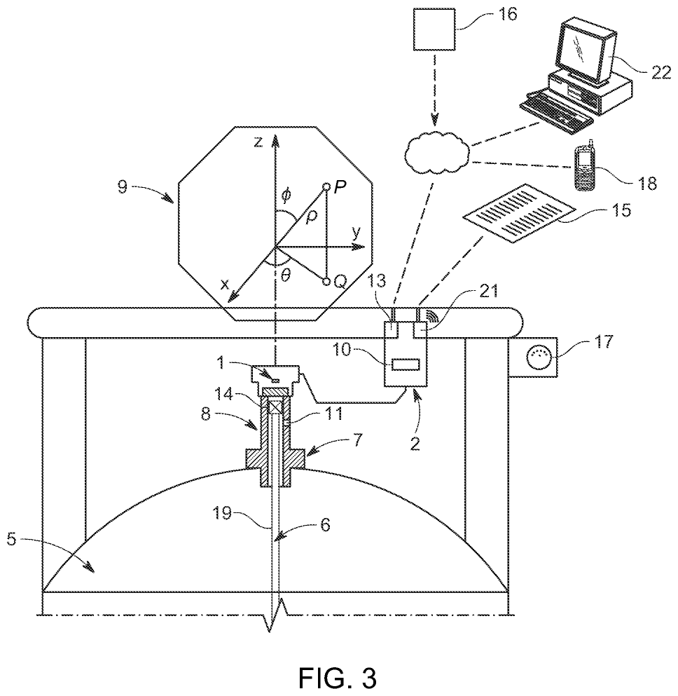

FIG. 2 shows one particular exemplary embodiment of High-sensitivity Multi-Axis Magnetometer Sensor 1 installed on the vessel 5, illustrated as Cryogenic Tank, with internal Float Assembly 6. Multi-Axis Magnetometer Sensor 1 is demonstrated mounted on the external part or exterior surface 7 of the Float Assembly 6, with wired connection to the Data Processing Device 2.

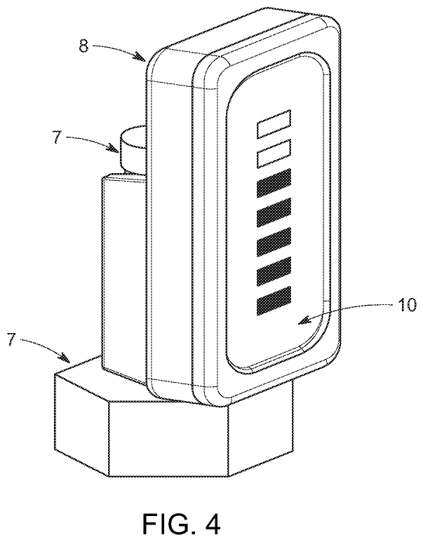

FIG. 3 shows one particular exemplary embodiment of High-sensitivity Multi-Axis Magnetometer Sensor 1 installed on the Cryogenic Tank or vessel 5 with internal Float Assembly 6. High-sensitivity Multi-Axis Magnetometer Sensor 1 is demonstrated located inside the Sensor Enclosure 8, mounted on or at the Knuckle Plug 7, that is part of the Float Assembly 6. High-sensitivity Multi-Axis Magnetometer Sensor 1 may have wired connection to the Data Processing Device 2, possibly with an embedded display 10 and audio/visual notification capability. High-sensitivity Multi-Axis Magnetometer Sensor 1 may be precisely aligned (horizontally and vertically) with the center of internal Float Assembly 6, enabling precise measurement of its dimensional magnetic field forces and vector components as demonstrated on the Sensor Coordinate System Schematic 9.

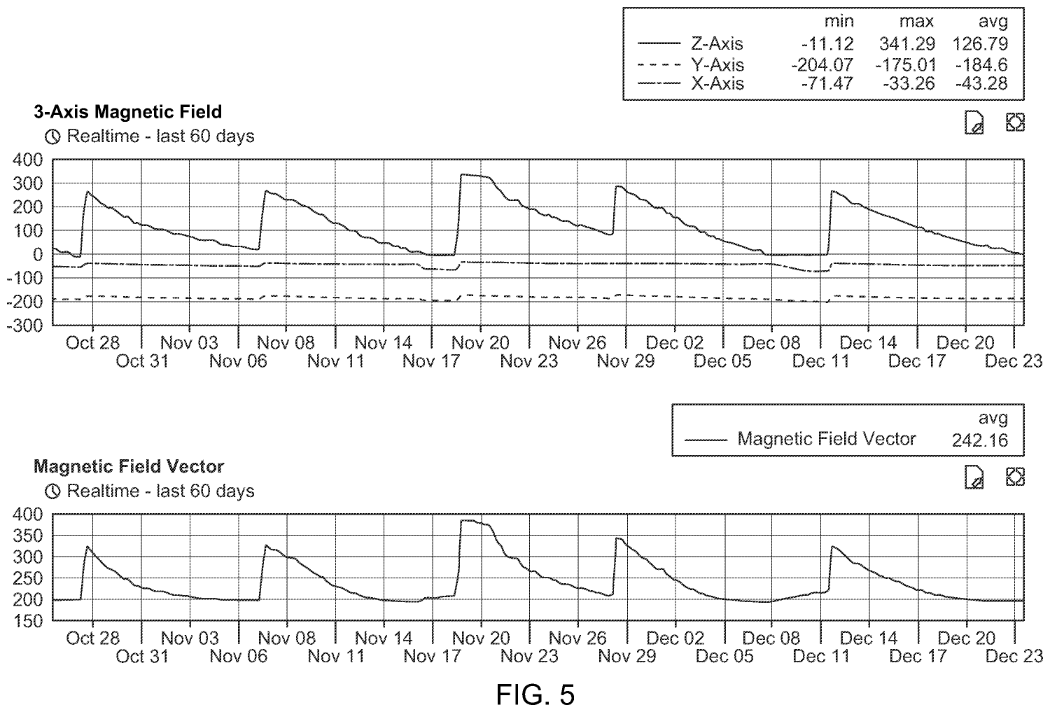

FIG. 4 shows one particular exemplary embodiment of High-sensitivity Multi-Axis Magnetometer Sensor 1 located inside the Sensor Enclosure 8, mounted on the top of the Knuckle Plug 7, that is external part of the Float Assembly 6. Digital Electrochromic Display 10 may be embedded into Sensor Enclosure 8, or connected thereto, such as through the data processing device 2 and is locally visualizing the level of cryogenic liquid inside the Cryogenic Tank. The display 10 provides an indication of liquid level in the vessel 5 based on the output from the multi-axis magnetometer sensor 1.

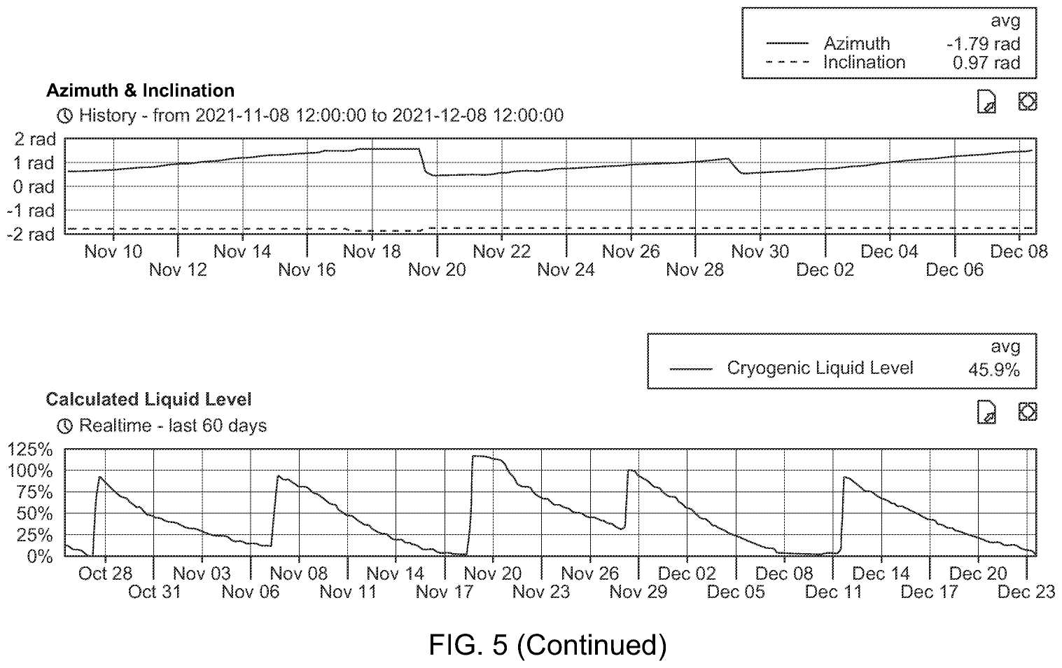

FIG. 5 shows one particular exemplary embodiment of data processing output from the mathematical software model hosted on the Cloud Data and Analytics platform 3. Aggregated data from a plurality of high-sensitivity multi-axis sensors 1 installed on the exemplary cryogenic liquid vessels 5 may be processed and visualized by the platform 3,16 to represent multiple dimensional parameters of the cryogenic liquid internal floats 6 (e.g. magnetic field for X, Y, Z axes; magnetic field azimuth and inclination; magnetic field vector, etc.) and to assist in calculating the precise level of cryogenic liquid inside the vessel 5 by communicating data and/or instructions back through the port 21 to the local data processing device 2.

Different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by this disclosure. It is indeed intended that the scope of this disclosure should be determined by a proper legal interpretation and construction of the disclosure, including equivalents, as understood by those of skill in the art relying upon the complete disclosure present at the time of filing.

What is claimed is:

1. A device for liquid level within a vessel having a float assembly shaft extending from the container, comprising:
a multi-axis magnetometer sensor, said multi-axis magnetometer sensor measuring magnetic forces of a magnet connected to a float assembly shaft extending from a vessel along x, y and z dimensional axes and provides an output;
a local data processing device receiving the output from the multi-axis magnetometer sensor assembly;
a local display providing an indication of liquid level in the vessel based on the output from the multi-axis magnetometer sensor; and
a communications port directing data from one of the local data processing device and the multi-axis magnetometer sensor to a remote data and analytics platform, said data and analytics platform at least monitoring liquid level inside the vessel for reporting remotely.

2. The device of claim 1 wherein the magnet is located at the upper end of the float assembly shaft of the cryogenic vessel.

3. The device of claim 1 wherein the local data processing device receives input from the communications port to assist in providing a liquid level output.

4. The device of claim 3 wherein the liquid level output is directed to the local display.

5. The device of claim 1 wherein the claim 1 wherein said multi-axis magnetometer sensor provides the output based on magneto-impedance and a magnetoresistive physical principal.

6. The device of claim 1 wherein the claim 1 wherein said multi-axis magnetometer sensor is mounted onto an external portion of the vessel.

7. The device of claim 1 wherein the multi-axis magnetometer sensor is aligned relative to a center of a float of the float assembly.

8. The device of claim 1 further comprising a temperature sensor providing temperature data.

9. The device of claim 8 wherein the temperature data is sent through the communications port to the remote data and analytics platform.

10. The device of claim 8 wherein the temperature data automatically compensates for variations in magnetic field related to changes in ambient temperature as sensed by the multi-axis magnetometer sensor before providing as output to the local data processing device.

11. The device of claim 1 wherein said display is a digital electrochromic display.

12. The device of claim 1 wherein said digital electrochromic display is printed on a plastic substrate.

13. The device of claim 1 wherein the remote data and analytics platform is hosted in the cloud and compiles data from multiple sensors to uniquely characterize data from each sensor and increase accuracy of cryogenic liquid level measurements inside various vessels.

14. The device of claim 1 wherein the remote data and analytics platform applies Artificial Intelligence data processing with strapping charts to more accurately predict liquid levels in the vessel.

15. The device of claim 1 in combination with a mobile/web App enabled on local user mobile device, said mobile/web App remotely connecting to the remote data and analytics platform.

16. The device of claim 15 wherein the mobile/web App provides a display of liquid level in the vessel.

17. The device of claim 15 wherein the mobile/web App is notified of a low level condition in the vessel.

18. The device of claim 15 wherein the Mobile/web App assists in scheduling refilling of the vessel.
